(19) United States
(12) Patent Application Publication
(10) Pub. No.: US 2026/0017108 A1
(43) Pub. Date: Jan. 15, 2026

(54) SYSTEMS AND METHODS FOR NON-LINEAR PRIORITY DATE SCHEDULING FOR GENETIC ALGORITHMS

(71) Applicant: nMetric, LLC, Dallas, TX (US)

(72) Inventors: Christine Koski, Dallas, TX (US); Stephen Cook, Albuquerque, NM (US)

(21) Appl. No.: 18/770,191

(22) Filed: Jul. 11, 2024

(51) Int. Cl. G06F 9/50

(52) U.S. Cl. CPC G06F 9/5038

(57) ABSTRACT

A computer-implemented scheduling method for a plurality of jobs that utilizes a genetic algorithm can generate a non-linear weighted matrix of requirements that is based on a fitness function that can be modified according to requirements and applied to generate schedules for corresponding genomes made up of a plurality of jobs. The matrix can be used to account for factors that traditional computing systems applying genetic algorithm-based scheduling simply cannot, resulting in gains in efficiency for the computing systems of the inventive subject matter.

### FIELD OF THE INVENTION

The field of the invention is computer-based scheduling systems.

### BACKGROUND

The background description includes information that may be useful in understanding the present invention. It is not an admission that any of the information provided herein is prior art or relevant to the presently claimed invention, or that any publication specifically or implicitly referenced is prior art.

Organizations such as companies all have different priorities for their scheduled work, based on their needs, production, customers, and other factors. These priorities can include on-time performance, limited inventory, maximum or minimum lateness, critical resource utilization, among others.

Given these different priorities, these organizations are left with a question: how can we meet differing individual client requirements with a single, same scheduling system?

Current scheduling solutions, including those that incorporate genetic algorithms, are not capable of differentiating or addressing potential tradeoffs in aggregate lateness between a number of late orders/late completion of tasks and/or jobs against the duration of the lateness for one or more of those tasks and/or jobs.

Traditional scheduling systems use linear fitness functions to balance factors such as earliness and lateness. Therefore, these traditional systems will determine that one job being five days late has the same fitness as five jobs being one day late. This problem carries over to early jobs as well—a five-day early job may offset a five-day late job, which then reduces the appropriate penalty within the system.

Thus, there is still a need for better prioritize the order in which jobs and tasks should be processed such that the effects of lateness across the jobs and tasks. As can be appreciated by the astute reader, the systems and methods of the inventive subject matter provide an improvement in computer-implemented scheduling systems because, among other things, they reach an optimized schedule faster than traditional systems, thus saving computing resources by shortening the amount of time a computing system takes to reach the optimal schedule for a plurality of jobs.

### SUMMARY OF THE INVENTION

The inventive subject matter provides apparatus, systems and methods in which a computing device generates a schedule via non-linear due-date priority scheduling with a genetic algorithm.

In embodiments of the inventive subject matter, a computing device such as a scheduling computer system first obtains a plurality of jobs, each of the plurality of jobs containing a plurality of tasks associated with the corresponding job. The computing device then generates a plurality of genomes based on the plurality of jobs.

The computing device generates a non-linear weighted matrix of requirements, and applies it to each of the plurality of genomes to then generate a corresponding schedule.

In embodiments of the inventive subject matter, the non-linear weighted matrix of requirements can include obtaining a fitness function and adding an non-one exponential to the fitness function. In embodiments, an earliness penalty can be calculated and applied to the genomes.

The computing device then calculates a fitness score for each of the plurality of possible schedules. After calculating the fitness scores, the computing device can determine the highest fitness score and keep the genome schedule associated with this highest fitness score.

The computing device can then generate a new set of genomes from the plurality of jobs and repeat the process to get a new highest fitness score. The process can continue a predetermined number of times or until a threshold has been met (e.g., a same score “winning” as the highest fitness score for a predetermined amount of times/rounds).

At this stage, the computing device applies the schedule having the “winning” fitness score to the plurality of jobs and can begin the execution of the jobs (or send a command to other computing devices and/or machinery associated with the jobs to begin executing the job) according to the winning schedule.

In embodiments of the inventive subject matter, the methods discussed herein are performed during a fitness evaluation phase of a genetic algorithm.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 is a flowchart of the processes executed by a computing device, according to embodiments of the inventive subject matter.

FIGS. 2A and 2B provide an illustrative example of the assembly of a genome, according to embodiments of the inventive subject matter.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:

Open shop scheduling. In open shop scheduling, each job has a task on each available machine, without any types of ordering constraints. Thus, the tasks can be performed in any order. Typically, there's no parallel work on a job.

Flow shop scheduling: In flow shop scheduling, each job has a task on each machine. Unlike open shop scheduling, the order of the tasks matters in flow shop scheduling.

Permutation flow shop: Permutation flow ship is similar to flow shop scheduling, but the machine must perform the jobs (and the tasks therein) in the same order.

Job shop (“JSP”) scheduling, also known as Job-Shop Scheduling Problem (“JSSP”): the goal for JSP is to minimize “makespan”. This means that the goal for JSP is to compress the schedule as much as possible.

Flexible job shop (“FJSP”) scheduling: This is similar to the job shop scheduling, but the resources are interchangeable.

Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*10⁶⁵ possible schedules.

While scheduling types with more restrictions have a lower potential amount of schedules, the combinations are still staggering and simply too many for a computer system to brute force a “best” schedule.

Current systems use simple heuristic deterministic scheduling algorithms:
R (Random)—Pick any Job in Queue with equal probability. This rule is often used as benchmark for other rules
FCFS (First Come First Serve)—Jobs are processed in the order in which they arrived at the work center (also called earliest release date)
SPT (Shortest Processing Time)—This rule tends to reduce both work-in-process inventory, the average job completion (flow) time, and average job lateness. SPT can also be used to break ties.
EDD (Earliest Due Date)—Choose Job that has earliest due date
CR (Critical Ratio)=Processing Time/Time until due (Due Date—Current Time). Take the highest value.
LWR (Least Work Remaining)—This rule is an extension of SPT variant that considers the number of successive operations
ST (Slack Time)=Time until job is due—(Sum of processing time remaining). Take the job with the smallest amount of slack time.
ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

As discussed herein a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

A genome as discussed herein can be considered to be a list of tasks. In the examples discussed herein, a genome can include all of the tasks from all of the jobs associated with an organization or a process within an organization.

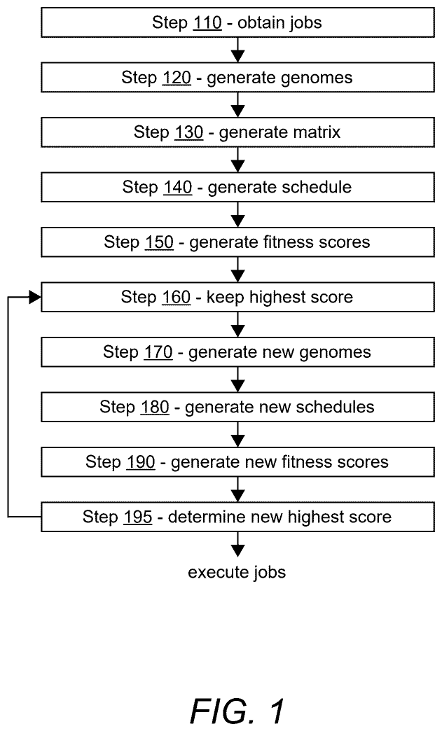

FIG. 1 is a flowchart of the processes executed by the computing device, according to embodiments of the inventive subject matter. The method of FIG. 1 is performed during a fitness evaluation phase of the execution of a genetic algorithm.

At step 110, the computing device obtains the plurality of jobs from a database of jobs.

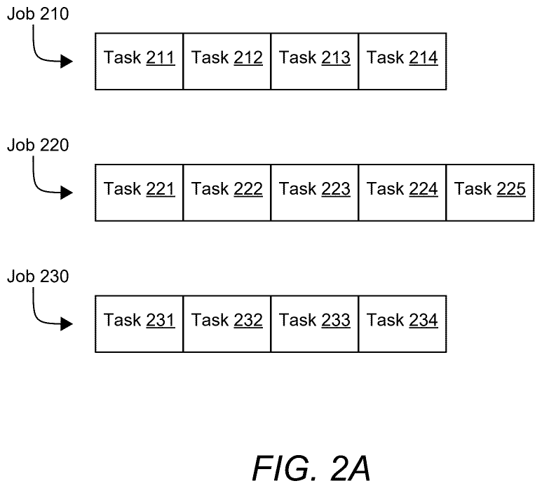

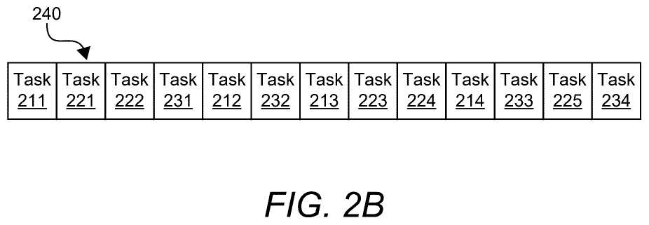

At step 120, the computing device generates a plurality of genomes based on the plurality of jobs. An example of the assembly of a genome is seen in FIGS. 2A and 2B.

FIG. 2A illustrates a plurality of jobs 210, 220, 230 with their respective tasks organized sequentially according to the job. Thus, job 210 will have task 1 (block 211), task 2 (block 212), task 3 (block 213) and task 4 (block 214) that need to be performed for the job 210 to be completed. Likewise, job 220 has tasks 1-5 (blocks 221-225, respectively) and job 230 has tasks 1-4 (blocks 231-234, respectively).

To create a genome, the computing device gets all of the tasks associated with all of the jobs and mixes them up to create a list from all of these tasks. FIG. 2B shows an example of a genome created from all of the tasks of jobs 210, 220 and 230. Generally speaking the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 213) of job 210 cannot be before task 2 (block 212) of the same job 210 within an assembled genome.

In embodiments of the inventive subject matter, the computing device can apply an earliness penalty to the generation of genomes.

At step 130, the computing device generates a non-linear weighted matrix of requirements. In embodiments of the inventive subject matter, the computing device generates a non-linear weighted matrix (also referred to as a non-linear function) by first obtaining a fitness function from a plurality of fitness functions stored in a database. Then, the computing device adds an exponential to the fitness function that does not equal one.

In embodiments of the inventive subject matter, the exponential can be less than one. In other embodiments of the inventive subject matter, the exponential can be greater than one.

In a practical example, an exponential above 1.0 provides a preference of scheduling 5 jobs one day late instead of one job 5 days late. Conversely, an exponential below 1.0 would schedule the opposite way—one job 5 days late instead of 5 jobs one day late.

In embodiments of the inventive subject matter, the computing device can apply the non-linear function to a penalty function as well. For example, in embodiments, the initial variable for the penalty function can be “seconds from due date”, and the non-linear weighted matrix can be applied to the variable. The computing device can then use the output of the penalty function as additional information for generating the corresponding schedule.

At step 140, the computing device applies the non-linear weighted matrix to each of the genomes and generates, for each of the generated genomes and as affected by the non-linear weighted matrix, a corresponding schedule.

At step 150, the computing devices generates a fitness score for each of the generated schedules.

At step 160, the computing device compares the generated fitness score, and keeps the schedule having the highest fitness score. In embodiments, the computing device can be programmed to keep more than one schedule. For example, the computing device can be programmed to keep the top three schedules with the highest fitness scores.

For all of the remaining fitness scores, the computing device discards them and generates a new plurality of genomes based on the available jobs at step 170, via the same process of step 120.

At step 180, the computing device applies the non-linear weighted matrix to each of the new genomes, generates a new schedule for each of the new genomes and then generates new fitness scores for each of the new schedules at step 190, via the same process of step 150.

At step 195, the computing device determines the genome schedule with the highest fitness score between the one or more schedules that were kept at step 160 and the new schedules generated at step 180. At this point, the computing device can move on and apply the schedule with the highest fitness score.

In embodiments of the inventive subject matter, the computing device can repeat the entire process a predetermined number of times. In other embodiments, the computing device can repeat the process of steps 160-195 for a predetermined number of times or until a particular outcome is reached. Each time, the highest score(s) are kept and compared to the newly-generated fitness scores, and then highest score(s) from this comparison are kept for the subsequent round. For example, the process can be repeated until one schedule is kept a predetermined number of times, which would reflect a confirmation that the schedule that “wins” repeatedly is the strongest schedule that can be generated from the plurality of jobs. Once this threshold met, the computing device moves on to apply the winning schedule to the plurality of jobs.

Following the determination of the winning schedule, the computing device can begin the execution of the jobs according to the winning schedule. This can include communicating the schedule or an order to begin a job or a task to one or more computing device and/or machinery that executes the jobs.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for non-linear priority date scheduling, comprising:
obtain, by a computing device, a plurality of jobs, each of the plurality of jobs containing a plurality of tasks associated with the corresponding job;
generate, by the computing device, a plurality of genomes based on the plurality of jobs;
generate, by the computing device, a non-linear weighted matrix of requirements;
apply, by the computing device, the non-linear weighted matrix of requirements to each of the plurality of genomes;
generate, by the computing device and for each of the plurality of genomes and the applied non-linear weighted matrix, a corresponding schedule;
calculate, by the computing device, a fitness score for each of the plurality of possible schedules;
keep, by the computing device, the genome schedule with the highest fitness score;
generate, by the computing device, a new plurality of genomes based on plurality of jobs;
apply, by the computing device, the non-linear weighted matrix to each of the new plurality of genomes;
generate, by the computing device and for each of the plurality of new genomes and the applied non-linear weighted matrix, a corresponding new schedule;
calculate, by the computing device, a new fitness score for each of the plurality of new schedules;
determine, by the computing device, the genome schedule with a new highest fitness score from the plurality of new genome schedules and the prior genome schedule with the highest fitness score; and
apply, by the computing device, the genome schedule with the new highest fitness score as a winning genome schedule to schedule the plurality of jobs according to the winning genome schedule.

2. The method of claim 1, wherein the method is performed during a fitness evaluation phase of a genetic algorithm.

3. The method of claim 1, wherein generating a non-linear weighted matrix of requirements further comprises:
obtaining a fitness function; and
adding an exponential to the fitness function that does not equal one.

4. The method of claim 3, wherein the exponential is lower than one.

5. The method of claim 3, wherein the exponential is higher than one.

6. The method of claim 1, further comprising applying an earliness penalty to generate genomes.

7. The method of claim 1, further comprising executing, by at least one of the computing device and a second computing device, the plurality of jobs according to the winning schedule.
